(19) United States
(12) Patent Application Publication
(10) Pub. No.: US 2017/0208619 A1
(43) Pub. Date: Jul. 20, 2017

(54) SCHEDULING REQUEST DURING CONNECTED DISCONTINUOUS RECEPTION OFF PERIOD

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/996,153

(22) Filed: Jan. 14, 2016

(51) Int. Cl. H04W 72/12; H04W 76/04

(52) U.S. Cl. CPC H04W 72/1284; H04W 76/048; H04W 72/1231

(57) ABSTRACT

A user equipment (UE) enhances battery power during a connected discontinuous reception (C-DRX) off period. In one instance, the UE determines whether data arrives in a buffer of the UE and when a scheduling request occasion falls into a C-DRX off period (connected discontinuous reception off period). The UE also delays sending a scheduling request when uplink pre-scheduling is supported by a serving base station based on the determining and based on a periodicity of uplink (UL) prescheduling for periodic uplink prescheduling and/or a length of an uplink pre-scheduled grant for non-periodic uplink prescheduling.

### BACKGROUND

Field

Aspects of the present disclosure relate generally to wireless communication systems, and more particularly, to scheduling requests during a discontinuous reception (DRX) cycle.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China employs TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method of wireless communication includes determining whether data arrives in a buffer of a UE (user equipment) and when a scheduling request occasion falls into a C-DRX off period (connected discontinuous reception off period). The method also includes delaying sending a scheduling request when uplink pre-scheduling is supported by a serving base station based on the determining and based on a periodicity of uplink (UL) prescheduling for periodic uplink prescheduling and/or a length of an uplink pre-scheduled grant for non-periodic uplink prescheduling.

According to another aspect of the present disclosure, an apparatus for wireless communication includes means for determining whether data arrives in a buffer of a UE (user equipment) and when a scheduling request occasion falls into a C-DRX off period (connected discontinuous reception off period). The apparatus may also include means for delaying sending a scheduling request when uplink pre-scheduling is supported by a serving base station based on the determining and based on a periodicity of uplink (UL) prescheduling for periodic uplink prescheduling and/or a length of an uplink pre-scheduled grant for non-periodic uplink prescheduling.

Another aspect discloses an apparatus for wireless communication and includes a memory and at least one processor (e.g., one or more processors) coupled to the memory. The processor(s) is configured to determine whether data arrives in a buffer of a UE (user equipment) and when a scheduling request occasion falls into a C-DRX off period (connected discontinuous reception off period). The processor(s) is also configured to delay sending a scheduling request when uplink pre-scheduling is supported by a serving base station based on the determining and based on a periodicity of uplink (UL) prescheduling for periodic uplink prescheduling and/or a length of an uplink pre-scheduled grant for non-periodic uplink prescheduling.

Yet another aspect discloses a non-transitory computer-readable storage medium having non-transitory program code recorded thereon which, when executed by the processor(s), causes the processor(s) to determine whether data arrives in a buffer of a UE (user equipment) and when a scheduling request occasion falls into a C-DRX off period (connected discontinuous reception off period). The program code also causes the processor(s) to delay sending a scheduling request when uplink pre-scheduling is supported by a serving base station based on the determining and based on a periodicity of uplink (UL) prescheduling for periodic uplink pre scheduling and/or a length of an uplink pre-scheduled grant for non-periodic uplink prescheduling.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in LTE.

FIG. 4 is a block diagram illustrating an example of a global system for mobile communications (GSM) frame structure.

FIG. 5 is a block diagram conceptually illustrating an example of a base station in communication with a user equipment (UE) in a telecommunications system.

FIG. 6 is a diagram illustrating network coverage areas according to aspects of the present disclosure.

FIG. 7 illustrates an exemplary discontinuous reception communication cycle.

FIG. 8 is a timeline illustrating an example of a scheduling request implementation during a connected discontinuous reception cycle according to aspects of the present disclosure.

FIG. 9 is a flow diagram illustrating a scheduling request method according to one aspect of the present disclosure.

FIG. 10 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

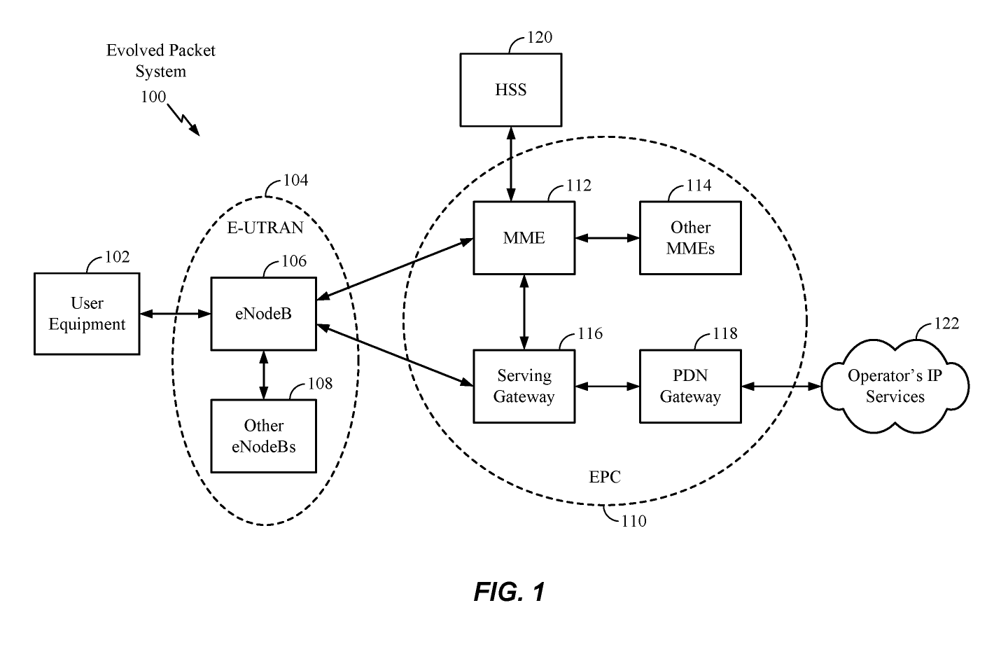

FIG. 1 is a diagram illustrating a network architecture 100 of a long term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity, those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

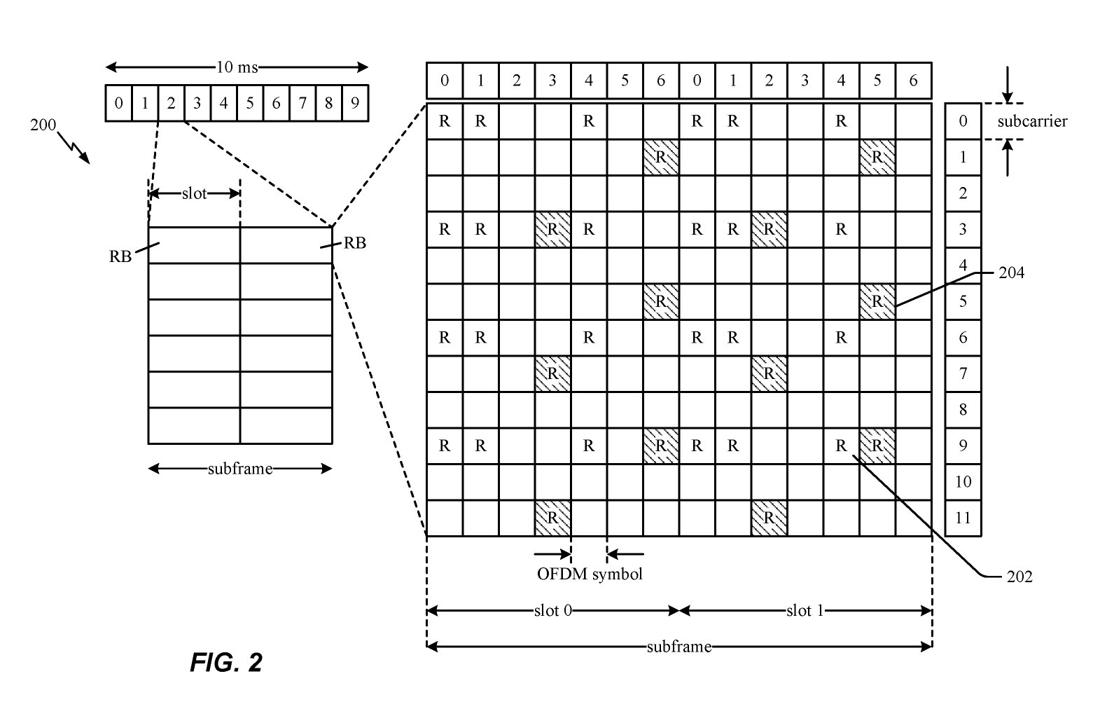

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each orthogonal frequency-division multiplexing (OFDM) symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

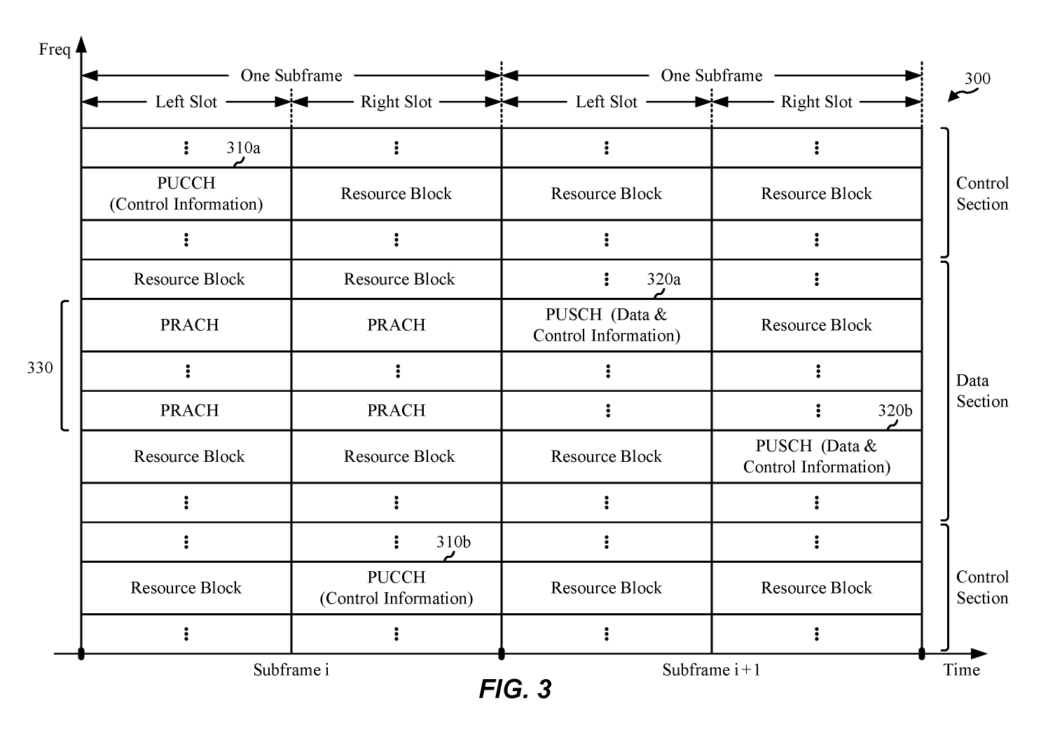

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

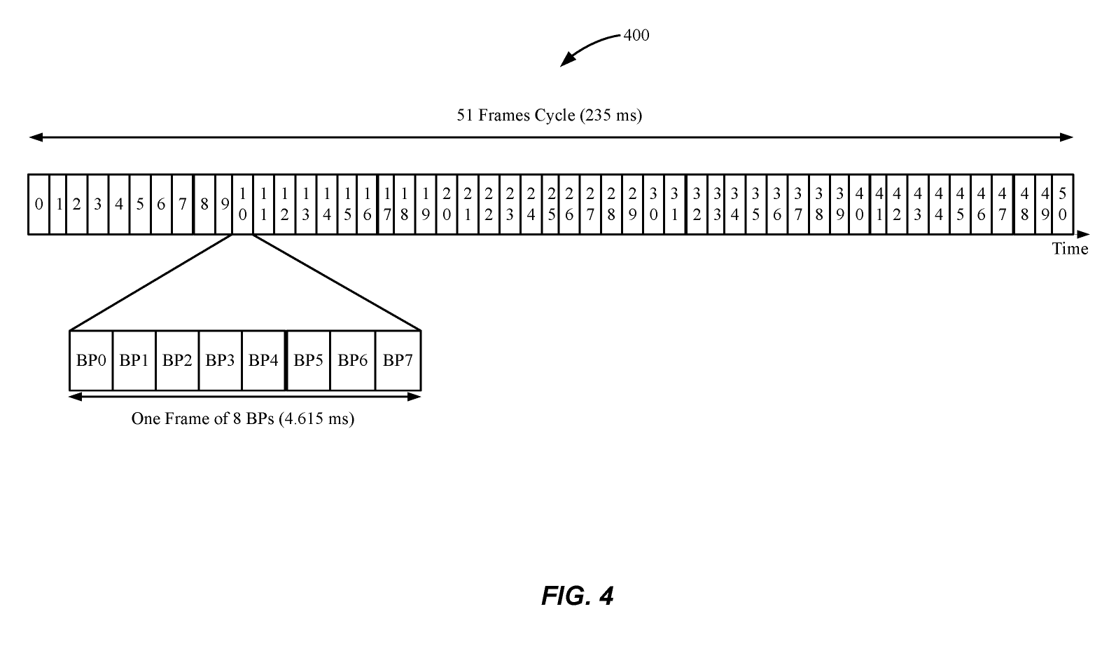

FIG. 4 is a block diagram illustrating an example of a global system for mobile communications (GSM) frame structure 400. The GSM frame structure 400 includes fifty-one frame cycles for a total duration of 235 ms. Each frame of the GSM frame structure 400 may have a frame length of 4.615 ms and may include eight burst periods, BP0-BP7.

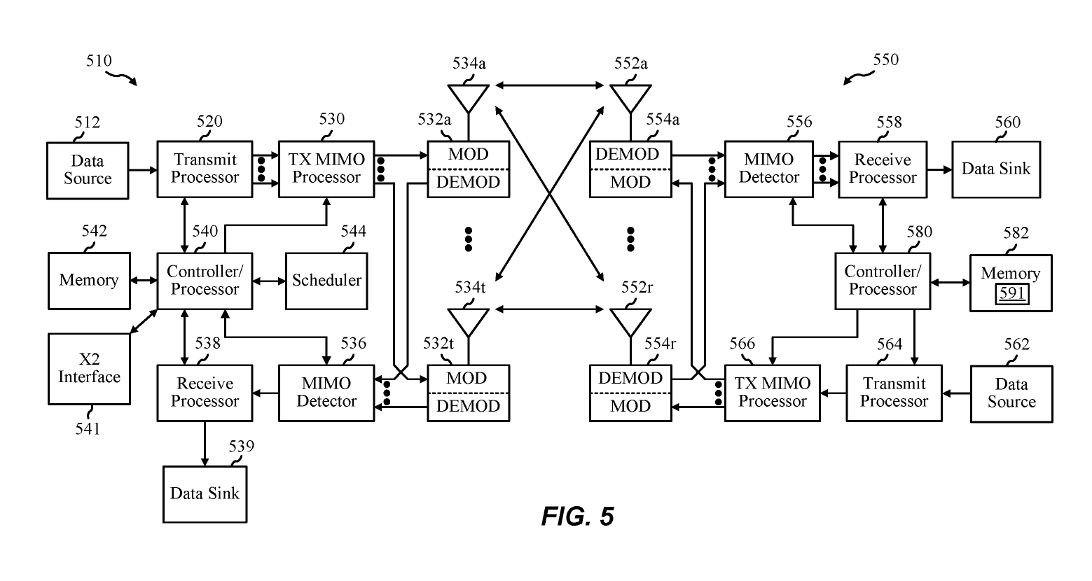

FIG. 5 is a block diagram of a base station (e.g., eNodeB or nodeB) 510 in communication with a UE 550 in an access network. In the downlink, upper layer packets from the core network are provided to a controller/processor 580. The base station 510 may be equipped with antennas 534a through 534t, and the UE 550 may be equipped with antennas 552a through 552r.

At the base station 510, a transmit processor 520 may receive data from a data source 512 and control information from a controller/processor 540. The control information may be for the physical broadcast channel (PBCH), physical control format indicator channel (PCFICH), physical hybrid ARQ indicator channel (PHICH), physical downlink control channel (PDCCH), etc. The data may be for the physical downlink shared channel (PDSCH), etc. The processor 520 may process (e.g., encode and symbol map) the data and control information to obtain data symbols and control symbols, respectively. The processor 520 may also generate reference symbols, e.g., for the PSS, SSS, and cell-specific reference signal. A transmit (TX) multiple-input multiple-output (MIMO) processor 530 may perform spatial processing (e.g., precoding) on the data symbols, the control symbols, and/or the reference symbols, if applicable, and may provide output symbol streams to the modulators (MODs) 532a through 532t. Each modulator 532 may process a respective output symbol stream (e.g., for OFDM, etc.) to obtain an output sample stream. Each modulator 532 may further process (e.g., convert to analog, amplify, filter, and upconvert) the output sample stream to obtain a downlink signal. Downlink signals from modulators 532a through 532t may be transmitted via the antennas 534a through 534t, respectively.

At the UE 550, the antennas 552a through 552r may receive the downlink signals from the base station 510 and may provide received signals to the demodulators (DEMODs) 554a through 554r, respectively. Each demodulator 554 may condition (e.g., filter, amplify, downconvert, and digitize) a respective received signal to obtain input samples. Each demodulator 554 may further process the input samples (e.g., for OFDM, etc.) to obtain received symbols. A MIMO detector 556 may obtain received symbols from all the demodulators 554a through 554r, perform MIMO detection on the received symbols if applicable, and provide detected symbols. A receive processor 558 may process (e.g., demodulate, deinterleave, and decode) the detected symbols, provide decoded data for the UE 550 to a data sink 560, and provide decoded control information to a controller/processor 580.

On the uplink, at the UE 550, a transmit processor 564 may receive and process data (e.g., for the PUSCH) from a data source 562 and control information (e.g., for the PUCCH) from the controller/processor 580. The processor 564 may also generate reference symbols for a reference signal. The symbols from the transmit processor 564 may be precoded by a TX MIMO processor 566 if applicable, further processed by the modulators 554a through 554r (e.g., for single carrier-frequency division multiple access (SC-FDMA), etc.), and transmitted to the base station 510. At the base station 510, the uplink signals from the UE 550 may be received by the antennas 534, processed by the demodulators 532, detected by a MIMO detector 536 if applicable, and further processed by a receive processor 538 to obtain decoded data and control information sent by the UE 550. The processor 538 may provide the decoded data to a data sink 539 and the decoded control information to the controller/processor 540. The base station 510 can send messages to other base stations, for example, over an X2 interface 541.

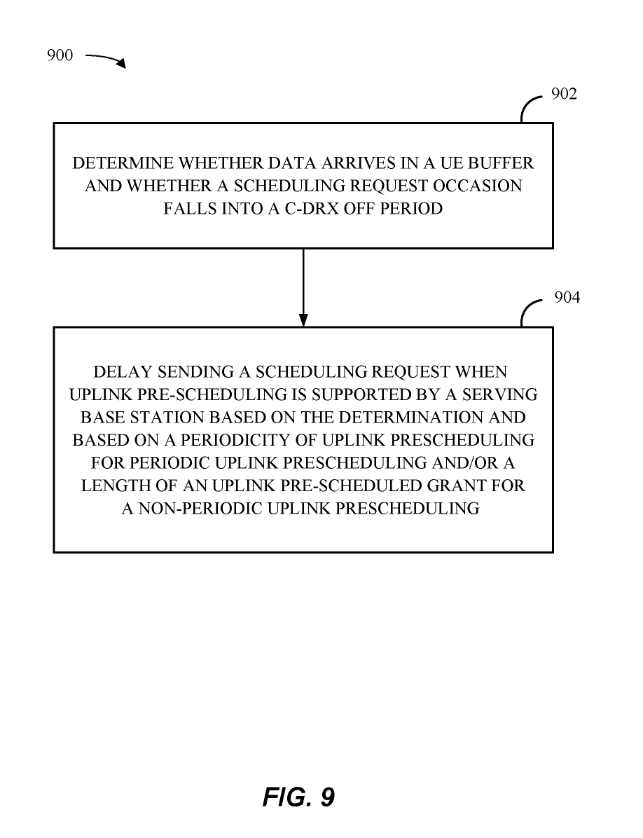

The controllers/processors 540 and 580 may direct the operation at the base station 510 and the UE 550, respectively. The processor 540/580 and/or other processors and modules at the base station 510/UE 550 may perform or direct the execution of the functional blocks illustrated in FIG. 9, and/or other processes for the techniques described herein. For example, the memory 582 of the UE 550 may store a scheduling request module 591 which, when executed by the controller/processor 580, configures the UE 550 to send a scheduling request during a discontinuous reception cycle according to one aspect of the present disclosure. The memories 542 and 582 may store data and program codes for the base station 510 and the UE 550, respectively. A scheduler 544 may schedule UEs for data transmission on the downlink and/or uplink.

In the uplink, the controller/processor 580 provides demultiplexing between transport and logical channels, packet reassembly, deciphering, header decompression, control signal processing to recover upper layer packets from the UE 550. Upper layer packets from the controller/processor 580 may be provided to the core network. The controller/processor 580 is also responsible for error detection using an acknowledgment (ACK) and/or negative acknowledgement (NACK) protocol to support HARQ operations.

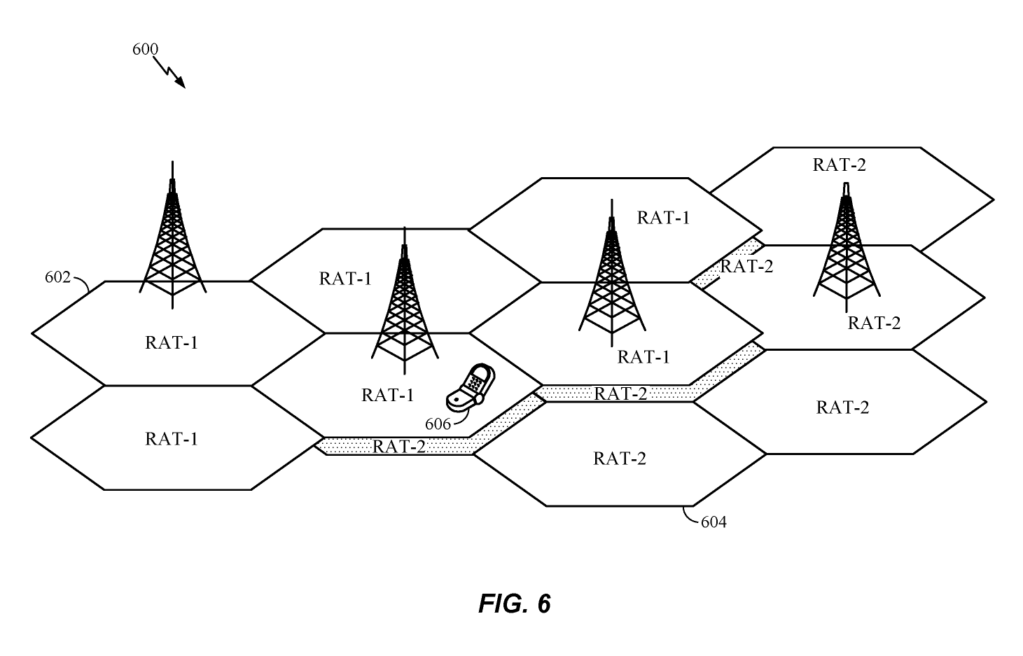

Some networks may be deployed with multiple radio access technologies. FIG. 6 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 600 includes RAT-1 cells 602 and RAT-2 cells 604. In one example, the RAT-1 cells are 2G or 3G cells and the RAT-2 cells are LTE cells. However, those skilled in the art will appreciate that other types of radio access technologies may be utilized within the cells. A user equipment (UE) 606 may move from one cell, such as a RAT-1 cell 602, to another cell, such as a RAT-2 cell 604. The movement of the UE 606 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., LTE) a UE may be specified to perform a measurement of a neighboring cell (such as a GSM cell). For example, the UE may measure the neighbor cells of a second network for signal strength, frequency channel, and base station identity code (BSIC). The UE may then connect to the strongest cell of the second network. Such measurement may be referred to as inter-radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter-RAT neighbor becomes better than another threshold). The LTE network may also allocate LTE measurement gaps. For example, the measurement gap for LTE is a 6 ms gap that occurs every 40 or 80 ms. The UE uses the measurement gap to perform 2G/3G measurements and LTE inter-frequency measurements.

The measurement gap may be used for multiple IRAT measurements and inter-frequency measurements. The inter-frequency measurements may include measurements of frequencies of a same RAT (e.g., serving LTE). The IRAT measurements may include measurements of frequencies of a different RAT (e.g., non-serving RAT such as wideband code division multiple access (WCDMA) or GSM). In some implementations, the LTE inter-frequency measurements and WCDMA IRAT measurements have a higher measurement scheduling priority than GSM.

Handover in conventional systems may be achieved by performing IRAT measurements and/or inter-frequency measurements. For example, the IRAT and/or inter-frequency searches and/or measurements include LTE inter-frequency searches and measurements, 3G searches and measurements, GSM searches and measurements, etc., followed by base station identity code (BSIC) procedures. The BSIC procedures include frequency correction channel (FCCH) tone detection and synchronization channel (SCH) decoding that are performed after signal quality measurements. After the measurements, the UE may send a measurement report to the serving RAT in a grant. The grant may be sent to the UE in response to a scheduling request by the UE.

Power savings is especially important to ensure improved battery life for wireless communications such as packet-switched devices (e.g., voice over LTE (VoLTE) devices) where voice calls (voice over internet protocol (VoIP) calls) can be frequent and long. During the wireless communications, such as the voice over internet protocol calls, voice packet arrivals may exhibit traffic characteristics that are discontinuous. A discontinuous reception (DRX) mechanism may be implemented to reduce power consumption based on the discontinuous traffic characteristics of the voice packet arrivals.

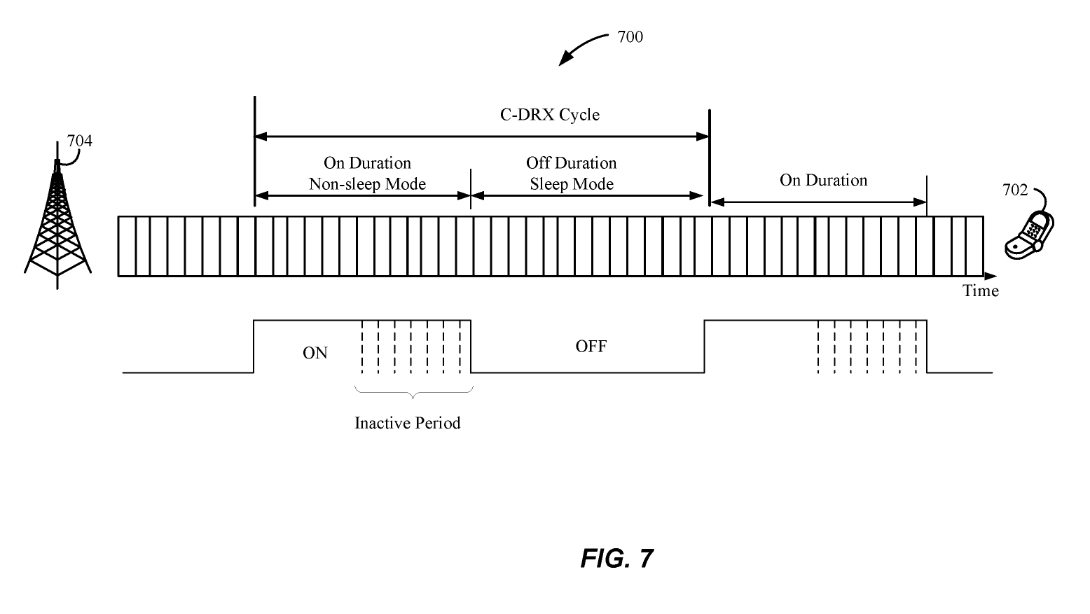

An exemplary discontinuous reception communication cycle 700 is illustrated in FIG. 7. The discontinuous reception cycle may correspond to a communication cycle where a user equipment (UE) 702 is in a connected mode (e.g., connected mode discontinuous reception (C-DRX) cycle). In the C-DRX cycle, the UE 702 may have an ongoing communication (e.g., voice call). For example, the ongoing communication may be discontinuous because of the inherent discontinuity in voice communications. The discontinuous communication cycle may also apply to other calls (e.g., multimedia calls).

The C-DRX cycle includes a time period/duration (e.g., C-DRX off duration or period) allocated for the UE 702 to sleep (e.g., sleep mode). In the sleep mode, the UE 702 may power down some of its components (e.g., receiver or receive chain is shut down). For example, when the UE 702 is in the connected state (e.g., RRC connected state) and communicating according to the C-DRX cycle, power consumption may be reduced by shutting down a receiver of the UE 702 for short periods. The C-DRX cycle also includes a time period when the UE 702 is awake (e.g., a non-sleep mode). The non-sleep mode may correspond to a time period (e.g., C-DRX on period) allocated for the UE to stay awake. The C-DRX on period includes a C-DRX on period and/or a C-DRX inactive period. The C-DRX on period corresponds to periods of communication (e.g., when the user is talking). The C-DRX inactive period, however, occurs during a pause in the communication (e.g., pauses in the conversation) that occurs prior to the C-DRX off period.

The UE 702 enters the sleep mode to conserve energy when the pause in the communication extends beyond a duration of an inactivity timer. A network may configure the inactivity timer. The inactivity timer defines the duration of the C-DRX inactive period. For example, the UE 702 enters the sleep mode when the inactivity timer initiated at a start of the pause, expires. In some implementations, a duration of the inactivity timer and corresponding C-DRX inactive period, the C-DRX on period and the C-DRX off period may be defined by the network. For example, the total DRX cycle may be 40 ms (e.g., one subframe corresponds to 1 ms). The C-DRX on period may have a duration of 4 subframes, the C-DRX inactive period may have a duration of 10 subframes and the C-DRX off period may have a duration of 26 subframes.

During the time period allocated for the non-sleep mode, such as the C-DRX inactive period, the UE 702 monitors for downlink information such as a grant. For example, the downlink information may include a physical downlink control channel (PDCCH) of each subframe. The PDCCH may carry information to allocate resources for UEs 702 and control information for downlink channels. During the sleep mode, however, the UE 702 skips monitoring the PDCCH to save battery power. To achieve the power savings, a serving base station (e.g., eNodeB) 704, which is aware of the sleep and non-sleep modes of the communication cycle, skips scheduling downlink transmissions during the sleep mode. Thus, the UE 702 does not receive downlink information during the sleep mode and can therefore skip monitoring for downlink information to save battery power.

For example, when the UE is in the connected state and a time between the arrival of voice packets is longer than the inactivity timer (e.g., inactivity timer expires between voice activity) the UE transitions into the sleep mode. A start of the inactivity timer may coincide with a start of the C-DRX inactive period of an ongoing communication. The end of the inactivity timer may coincide with a start of the sleep mode or an end to the non-sleep mode provided there is no intervening reception of data prior to the expiration of the inactivity timer. When there is an intervening reception of data, the inactivity timer is reset.

In some implementations, the UE is awake during the time period (e.g., C-DRX off period) allocated for the sleep mode. During the C-DRX off period, the UE evaluates neighbor cells by performing activities or measurement procedures. For example, the UE performs neighbor RAT (e.g., global system for mobile (GSM)) measurements (e.g., inter-radio access technology (IRAT) measurements) for a list of frequencies (e.g., GSM absolute radio frequency channel numbers (ARFCNs)). The measurement procedures may include signal quality measurements and synchronization channel decoding procedures (e.g., frequency correction channel (FCCH) tone detection and/or synchronization channel (SCH) decoding).

A UE may enter a C-DRX off period allocated for the UE 702 to sleep (e.g., sleep mode). In the sleep mode, the UE 702 may power down some of its components (e.g., receiver or receive chain is shut down). The UE may transition to a C-DRX on period. After the UE transitions into the C-DRX on period, the UE sends a scheduling request, monitors for a grant channel, and then sends a measurement report using a received grant. In some instances, however, delaying the measurement report until the scheduled end of the C-DRX off period may cause call drops when a signal quality of a serving cell of a first RAT (e.g., LTE serving cell) degrades quickly.

A base station, such as the LTE eNodeB, adaptively adjusts a scheduling request period based on scheduling request loads. The scheduling request period defines how often the UE can send a scheduling request. The adjustment is defined as a scheduling request indicator period adaptation. Scheduling request indicator loads are classified. For example, the scheduling request indicator loads are classified into low, medium, high, and excessively high. The classification of the scheduling request indicator loads (e.g., low scheduling request indicator loads) is determined based on a number of admitted UEs, and the usage of scheduling request indicator channel resources. For example, a scheduling request period or periodicity of the scheduling request is shorter when the number of UEs is smaller.

Because of the adjustments, scheduling request periods may occur during the C-DRX off period (e.g., the period allocated for sleep mode). Thus, when application data arrives at a buffer of the UE, the UE wakes up prior to a scheduled end of the C-DRX off period. Waking up prior to the scheduled end of the C-DRX off period to send a scheduling request decreases the battery power of the UE.

### Scheduling Request During Connected Discontinuous Reception Off Period

Aspects of the present disclosure are directed to enhancing battery power during the connected discontinuous reception (C-DRX) off period. In some aspects of the disclosure, a user equipment (UE) determines whether to communicate with a serving base station when data arrives at a buffer of a UE and a scheduling request (SR) occasion falls into the C-DRX off period. The scheduling request occasion is a period in which the UE can send a scheduling request to a base station on an uplink channel. The scheduling request occasion may be defined by a network during a call setup. For example, the UE determines whether to wake up during the C-DRX off period and send a scheduling request during the scheduling request occasion.

In one aspect of the disclosure, the UE determines whether to wake up and send the scheduling request when the scheduling request occasion occurs during the C-DRX off period based on whether a serving base station supports uplink pre-scheduling. Whether the serving base station supports uplink pre-scheduling may be determined based on a record or history. For example, the UE may store a list of unique global identifications of base stations (e.g., eNodeBs) that support uplink pre-scheduling and may store other uplink pre-scheduling information. The other uplink pre-scheduling information may include a periodicity of the uplink pre-scheduling for periodic uplink prescheduling, a number of uplink pre-scheduling grants and a length of uplink pre-scheduled grants for non-periodic uplink prescheduling.

A base station that supports uplink pre-scheduling autonomously sends the UE uplink pre-scheduling information without receiving a scheduling request (e.g., periodically) from the UE. For example, when the uplink pre-schedule is executed, the base station periodically sends uplink grants without receiving a scheduling request from the UE. The uplink pre-scheduling information may convey various parameters for uplink data transmission. For example, the uplink pre-scheduling information may include an uplink grant that is received by the UE without the UE sending the schedule request for the uplink grant and/or uplink buffer status.

When the UE determines that the serving base station supports uplink pre-scheduling, the UE adjusts (e.g., delays) sending the scheduling request. For example, in a next C-DRX on period, a serving cell (e.g., LTE cell) may allocate an uplink grant without receiving a scheduling request from the UE. However, if no grant is allocated, the UE sends the scheduling request in the next C-DRX on period during the next scheduling request occasion, and receives the uplink grant based on the scheduling request. The UE sends a buffer status report using the uplink grant received from the serving base station. The buffer status report includes all data in the buffer of the UE. For example, the UE sends all data in one or more physical uplink shared channel (PUSCH) transmissions.

In another aspect of the disclosure, the UE delays sending the scheduling request when uplink pre-scheduling is supported by the serving base station based on the periodicity of the uplink pre-scheduling for periodic uplink prescheduling and/or the length of uplink pre-scheduled grants for non-periodic uplink prescheduling. The periodicity of the uplink pre-scheduling and/or a length of the uplink pre-scheduled grants may be determined or identified based on the record. For example, the UE may record previous uplink pre-scheduling information such as uplink pre-scheduling periodicity and length of the uplink pre-scheduled grants in memory. The UE may access the previously stored uplink pre-scheduling information to determine an expected scheduling request occasion and corresponding information associated with the scheduling request occasion. The corresponding information may include the uplink pre-scheduling periodicity that is used to determine when to expect a next scheduling request occasion and a length of the grant to expect in the next scheduling request occasion. For example, when the uplink pre-scheduling periodicity is short, the UE delays sending the scheduling request until the next scheduling request occasion. However, when the uplink pre-scheduling periodicity is long, the UE does not delay sending the scheduling request until the next scheduling request occasion.

In yet another aspect of the disclosure, the UE adjusts the sending of the scheduling request based on a signal quality of the serving base station. For example, the UE sends the scheduling request to the serving base station when a signal quality of the serving base station is below a threshold. This follows because the UE may desire to schedule transmission of a measurement report to facilitate handover of the UE to a desirable target base station. In this case, the UE sends the scheduling request to the serving base station to request a grant to expedite the sending of the measurement report.

In a further aspect of the disclosure, the UE adjusts the sending of the scheduling request based on power headroom of the UE. The power headroom of the UE indicates how much transmission power is left for a UE to use in addition to the power being used by current transmission. For example, the UE sends the scheduling request to the serving base station when the power headroom is below a threshold.

Furthermore, the UE adjusts the sending of the scheduling request based on a remaining duration of the C-DRX off period. For example, the UE delays sending the scheduling request to the serving base station when the remaining duration (e.g., remaining sleep time) of the C-DRX off period is below a threshold. Thus, rather than waking up and sending the scheduling request, the UE continues to sleep during the scheduled C-DRX off period to save battery power when the remaining duration is below the threshold.

The UE further adjusts the sending of the scheduling request based on whether a quality of service requirement for an application running on the UE is satisfied. For example, the adjusting is based on whether an application latency specification exceeds a time until a next scheduling request occasion occurs during a C-DRX on duration.

When the latency requirement exceeds the time until the next scheduling request occasion, the UE delays the scheduling request until the next scheduling request occasion. However, when the latency requirement is less than the time until the next scheduling request occasion, the UE sends the scheduling request to the serving base station.

The time until the next scheduling request occasion corresponds to a time duration starting from a time of an arrival of a first scheduling request occasion in a current C-DRX off period until an expected time of arrival of a next scheduling request occasion in a next C-DRX on period. In some instances, the UE accounts for uplink scheduling delays. In this case, the time corresponds to the time duration starting from the time of the arrival of the first scheduling request occasion in the current C-DRX off period until the expected time of arrival of the next scheduling request occasion in the next C-DRX on period plus the uplink scheduling delay.

In other aspects, the UE adjusts the sending of the scheduling request based on a remaining battery level of the UE. For example, the UE delays sending the scheduling request to the serving base station when the battery level is low or when the battery level is below a threshold. In this case, the UE delays the scheduling request until a next C-DRX on period regardless of the application latency requirement.

In addition, the UE adjusts or determines whether to adjust the sending of the scheduling request based on whether the UE supports performing serving RAT inter-frequency measurements (radio access technology inter-frequency measurements) and/or IRAT measurements (inter-RAT measurements) during the C-DRX off period. For example, when the UE uses the C-DRX off period for measurements, the UE delays sending of the scheduling request during the scheduling request occasion that occurs in the C-DRX off period. However, when the C-DRX off period is not used for measurements (e.g., the UE uses measurement gaps or a second receiver for measurements), the UE does not delay sending the scheduling request during the scheduling request occasion that occurs in the C-DRX off period.

The UE further adjusts or determines whether to adjust the sending of the scheduling request based on a percentage of scheduling request occasions falling into the C-DRX off period and/or a percentage of the scheduling request occasions falling into the C-DRX on period. For example, when a high percentage (e.g., based on a threshold) of the scheduling request occasions falls in the C-DRX off period and a low percentage (e.g., based on a threshold) falls in the C-DRX on period, the UE delays sending the scheduling request to save battery power. However, when a low percentage of the scheduling request occasions falls in the C-DRX off period and a high percentage falls in the C-DRX on period, the UE does not delay sending the scheduling request because the battery power savings is small.

Furthermore, the UE determines whether to delay sending the scheduling request based on information in the buffer of the UE. For example, when the information in the buffer of the UE is a measurement report for handover, the UE does not delay sending scheduling request.

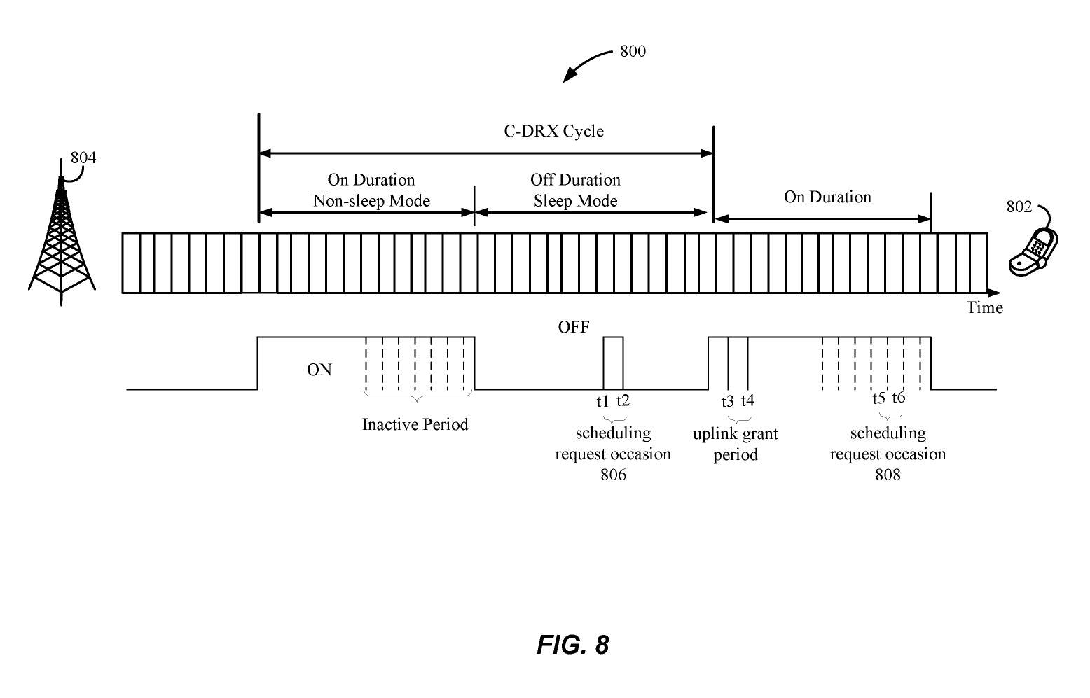

FIG. 8 is a timeline 800 illustrating an example of a scheduling request implementation during a connected discontinuous reception (C-DRX) cycle according to aspects of the present disclosure. Similar to the discontinuous reception cycle illustrated in FIG. 7, the scheduling request implementation illustrated by the timeline 800 is directed to wireless communication during a discontinuous reception cycle. For example, FIG. 8 illustrates a discontinuous reception cycle that corresponds to a communication cycle where a user equipment (UE) 802 is in a connected mode with a base station 804. The C-DRX cycle includes a time period/duration (e.g., C-DRX off period) allocated for the UE 802 to sleep. The UE 802 enters the C-DRX off period to conserve energy when a pause in the communication extends beyond a duration of an inactivity timer.

In some instances, a scheduling request occasion 806 (e.g., at time period t1-t2) may occur during the C-DRX off period. When the scheduling request occasion 806 occurs during the C-DRX off period and data for transmission exists in the buffer of the UE 802, the UE 802 determines whether to wake up during the C-DRX off period and send a scheduling request for a grant during the scheduling request occasion 806. The determination may be based on whether the serving base station supports uplink pre-scheduling. When the UE 802 determines that the base station supports uplink pre-scheduling, the UE 802 delays sending of the scheduling request for the grant. Instead, the UE 802 receives the grant (e.g., for time period t3-t4) from the serving base station for transmitting the data at the buffer of the UE without sending the scheduling request to the serving base station. The UE 802 can send the data in the buffer during the uplink grant period t3-t4, thereby saving battery power by suspending or delaying the sending of the scheduling request. However, if no grant is allocated, the UE 802 sends the scheduling request in the next C-DRX on period during the next scheduling request occasion 808, and receives the uplink grant based on the scheduling request.

The proposed method effectively saves UE battery without impacting a user's perception of the service.

FIG. 9 is a flow diagram illustrating a scheduling request method 900 according to one aspect of the present disclosure. At block 902, a user equipment (UE) determines whether data arrives in a buffer of a UE and whether a scheduling request occasion falls into a C-DRX off period. At block 904, the UE delays sending a scheduling request when uplink pre-scheduling is supported by a serving base station based on the determination and based on a periodicity of uplink (UL) prescheduling for periodic prescheduling and/or a length of an uplink pre-scheduled grant for non-periodic uplink prescheduling.

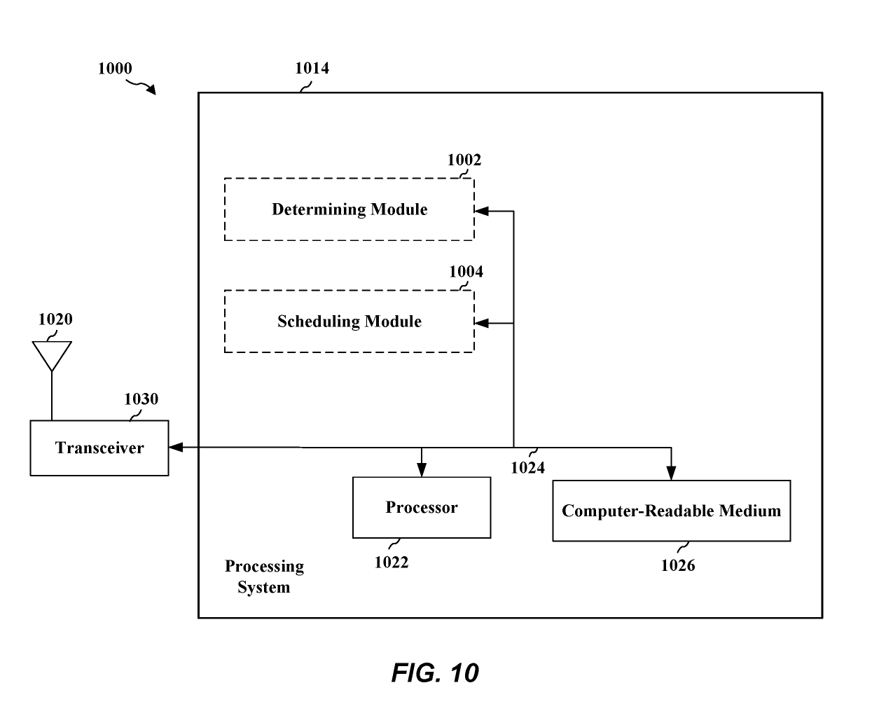

FIG. 10 is a diagram illustrating an example of a hardware implementation for an apparatus 1000 employing a processing system 1014 according to one aspect of the present disclosure. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022, a determining module 1002, a scheduling module 1004 and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a determining module 1002 for determining whether data arrives in a buffer of a UE and when a scheduling request occasion falls into a C-DRX off period. The processing system 1014 also includes a scheduling module 1004 for delaying sending a scheduling request when uplink pre-scheduling is supported by a serving base station based on the determination and based on a periodicity of uplink (UL) prescheduling and/or a length of an uplink pre-scheduled grant. The determining module 1002 and/or the scheduling module 1004 may be software module(s) running in the processor 1022, resident/stored in the computer-readable medium 1026, one or more hardware modules coupled to the processor 1022, or some combination thereof. The processing system 1014 may be a component of the UE 550 of FIG. 5 and may include the memory 582, and/or the controller/processor 580.

In one configuration, an apparatus such as a UE 550 is configured for wireless communication including means for determining. In one aspect, the determining means may be the controller/processor 580, the memory 582, the scheduling request module 591, the determining module 1002, and/or the processing system 1014 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 550 is configured for wireless communication including means for scheduling. In one aspect, the scheduling means may be the controller/processor 580, the memory 582, the scheduling request module 591, the scheduling module 1004, and/or the processing system 1014 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to an LTE system. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in frequency division duplex (FDD), time division duplex (TDD), or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether data arrives in a buffer of a UE (user equipment) and when a scheduling request occasion falls into a C-DRX off period (connected discontinuous reception off period), and
delaying sending a scheduling request when uplink pre-scheduling is supported by a serving base station based at least in part on the determining and based at least in part on a periodicity of uplink (UL) prescheduling for periodic uplink prescheduling and/or a length of an uplink pre-scheduled grant for non-periodic uplink prescheduling.

2. The method of claim 1, further comprising sending the scheduling request to the serving base station when a signal quality of the serving base station is below a threshold.

3. The method of claim 1, further comprising sending the scheduling request to the serving base station when power headroom is below a threshold.

4. The method of claim 1, further comprising delaying sending the scheduling request when a remaining sleep time during the C-DRX off period is below a threshold.

5. The method of claim 1, further comprising delaying sending the scheduling request based at least in part on a remaining battery level of the UE.

6. The method of claim 1, further comprising determining whether to delay sending the scheduling request based at least in part on whether the UE supports performing serving RAT inter-frequency measurements (radio access technology inter-frequency measurements) and/or IRAT measurements (inter-RAT measurements) during the C-DRX off period and/or whether the UE supports performing serving RAT inter-frequency measurements and/or the IRAT measurements with a second receiver.

7. The method of claim 1, further comprising determining whether to delay sending the scheduling request based at least in part on a percentage of scheduling request occasions falling into the C-DRX off period and/or the percentage of scheduling request occasions falling into a C-DRX on period.

8. The method of claim 1, further comprising determining whether to delay sending the scheduling request based at least in part on information in the buffer of the UE.

9. An apparatus for wireless communication, comprising:
means for determining whether data arrives in a buffer of a UE (user equipment) and when a scheduling request occasion falls into a C-DRX off period (connected discontinuous reception off period), and
means for delaying sending a scheduling request when uplink pre-scheduling is supported by a serving base station based at least in part on the determining and based at least in part on a periodicity of uplink (UL) prescheduling for periodic uplink prescheduling and/or a length of an uplink pre-scheduled grant for non-periodic uplink prescheduling.

10. The apparatus of claim 9, further comprising means for sending the scheduling request to the serving base station when a signal quality of the serving base station is below a threshold.

11. The apparatus of claim 9, further comprising means for sending the scheduling request to the serving base station when power headroom is below a threshold.

12. The apparatus of claim 9, further comprising means for delaying sending the scheduling request when a remaining sleep time during the C-DRX off period is below a threshold.

13. The apparatus of claim 9, further comprising means for delaying sending the scheduling request based at least in part on a remaining battery level of the UE.

14. The apparatus of claim 9, further comprising means for determining whether to delay sending the scheduling request based at least in part on whether the UE supports performing serving RAT inter-frequency measurements (radio access technology inter-frequency measurements) and/or IRAT measurements (inter-RAT measurements) during the C-DRX off period and/or whether the UE supports performing serving RAT inter-frequency measurements and/or the IRAT measurements with a second receiver.

15. The apparatus of claim 9, further comprising means for determining whether to delay sending the scheduling request based at least in part on a percentage of scheduling request occasions falling into the C-DRX off period and/or the percentage of scheduling request occasions falling into a C-DRX on period.

16. An apparatus for wireless communication, comprising:
a memory;
a transceiver configured for wireless communication; and
at least one processor coupled to the memory and the transceiver, the at least one processor configured:
to determine whether data arrives in a buffer of a UE (user equipment) and when a scheduling request occasion falls into a C-DRX off period (connected discontinuous reception off period), and
to delay sending a scheduling request when uplink pre-scheduling is supported by a serving base station based at least in part on the determining and based at least in part on a periodicity of uplink (UL) prescheduling for periodic uplink prescheduling and/or a length of an uplink pre-scheduled grant for non-periodic uplink prescheduling.

17. The apparatus of claim 16, in which the at least one processor is further configured to send the scheduling request to the serving base station when a signal quality of the serving base station is below a threshold.

18. The apparatus of claim 16, in which the at least one processor is further configured to send the scheduling request to the serving base station when power headroom is below a threshold.

19. The apparatus of claim 16, in which the at least one processor is further configured to delay sending the scheduling request when a remaining sleep time during the C-DRX off period is below a threshold.

20. The apparatus of claim 16, in which the at least one processor is further configured to delay sending the scheduling request based at least in part on a remaining battery level of the UE.

21. The apparatus of claim 16, in which the at least one processor is further configured to determine whether to delay sending the scheduling request based at least in part on whether the UE supports performing serving RAT inter-frequency measurements (radio access technology inter-frequency measurements) and/or IRAT measurements (inter-RAT measurements) during the C-DRX off period and/or whether the UE supports performing serving RAT inter-frequency measurements and/or the IRAT measurements with a second receiver.

22. The apparatus of claim 16, in which the at least one processor is further configured to determine whether to delay sending the scheduling request based at least in part on a percentage of scheduling request occasions falling into the C-DRX off period and/or the percentage of scheduling request occasions falling into a C-DRX on period.

23. The apparatus of claim 16, in which the at least one processor is further configured to determine whether to delay sending the scheduling request based at least in part on information in the buffer of the UE.

24. A non-transitory computer-readable storage medium having non-transitory program code recorded thereon, the program code comprising:
program code to determine whether data arrives in a buffer of a UE (user equipment) and when a scheduling request occasion falls into a C-DRX off period (connected discontinuous reception off period), and
program code to delay sending a scheduling request when uplink pre-scheduling is supported by a serving base station based at least in part on the determining and based at least in part on a periodicity of uplink (UL) prescheduling for periodic uplink prescheduling and/or a length of an uplink pre-scheduled grant for non-periodic uplink prescheduling.

25. The non-transitory computer-readable storage medium of claim 24, in which the program code is further configured to cause the UE to send the scheduling request to the serving base station when a signal quality of the serving base station is below a threshold.

26. The non-transitory computer-readable storage medium of claim 24, in which the program code is further configured to cause the UE to send the scheduling request to the serving base station when power headroom is below a threshold.

27. The non-transitory computer-readable storage medium of claim 24, in which the program code is further configured to cause the UE to delay sending the scheduling request when a remaining sleep time during the C-DRX off period is below a threshold.

28. The non-transitory computer-readable storage medium of claim 24, in which the program code is further configured to cause the UE to delay sending the scheduling request based at least in part on a remaining battery level of the UE.

29. The non-transitory computer-readable storage medium of claim 24, in which the program code is further configured to determine whether to delay sending the scheduling request based at least in part on whether the UE supports performing serving RAT inter-frequency measurements (radio access technology inter-frequency measurements) and/or IRAT measurements (inter-RAT measurements) during the C-DRX off period and/or whether the UE supports performing serving RAT inter-frequency measurements and/or the IRAT measurements with a second receiver.

30. The non-transitory computer-readable storage medium of claim 24, in which the program code is further configured to determine whether to delay sending the scheduling request based at least in part on a percentage of scheduling request occasions falling into the C-DRX off period and/or the percentage of scheduling request occasions falling into a C-DRX on period.
